(19) United States
(12) Patent Application Publication
(10) Pub. No.: US 2017/0167070 A1
(43) Pub. Date: Jun. 15, 2017

(54) Lid Assembly

(71) Applicant: Electrolux Thailand Co., Ltd., Bangkok (TH)

(72) Inventors: Chatchawan Khamprachom, Stockholm (SE); Pankaj Jadhav, Stockholm (SE); Worawoot Kongpisootpaisahn, Stockholm (SE); Suttipong Thongklom, Stockholm (SE); Swaminathan Iyer, Stockholm (SE)

(21) Appl. No.: 15/374,155

(22) Filed: Dec. 9, 2016

(30) Foreign Application Priority Data
Dec. 11, 2015 (AU) 2015268668

(51) Int. Cl. D06F 39/14; E06B 3/72

(52) U.S. Cl. CPC D06F 39/14; E06B 3/72

(57) ABSTRACT

A lid assembly (10) for a washing machine having a frame formed by a frame bottom (3) and a frame top (2) attached to the frame bottom and top section (1) attached to the frame top. The top section of the lid assembly can be varied so that the appearance of the lid assembly can be easily altered.

### CROSS-REFERENCE TO RELATED APPLICATION

The present application claims priority to Australian Application 2015268668 filed Dec. 11, 2015 which application is hereby incorporated by reference in its entirety.

### TECHNICAL FIELD

The present disclosure relates to a washing machine. In particular the present disclosure relates to a lid assembly for a washing machine.

### BACKGROUND

Washing machines are provided with lids. The lids can be formed in many different designs. In some designs the lid can have a transparent section. For top loaded washing machines the lid can be formed, at least partly by a glass material. For example WO2014/120739 describes a lid for a washing machine with glass.

There is a constant desire to improve the design of a washing machine. Hence, there is a need for a washing machine having an improved lid assembly.

### SUMMARY

It is an object of the present invention to provide an improved washing machine. It is a particular object of the present invention to provide an improved washing machine with an improved lid assembly.

As has been realized there is a demand for different designs of a washing machine. One element of the washing machine that can be used to alter the design of a washing machine is the design of the lid of a washing machine. Hence it would be advantageous if, during assembly of the lid, the appearance of the lid could be altered with minimum effort and with few different components to reduce the number of items used to at the same time provide a large number of different designs. To accomplish such an assembly a supporting frame that can receive many different top sections can be provided.

In accordance with one embodiment a lid assembly for a washing machine is provided. The lid assembly comprises a frame and top section. The frame is formed by a frame bottom and a frame top attached to the frame bottom and top section attached to the frame top. Hereby a lid assembly in which the top section of the lid assembly can be varied so that the appearance of the lid assembly can be easily altered.

In accordance with one embodiment the frame top has an inner surface adapted to fit with the top section.

In accordance with one embodiment the frame top is screwed to the frame bottom. In accordance with one embodiment the frame top is snap fit to the frame bottom.

In accordance with one embodiment the top section is attached to the frame top by glue or adhesive.

In accordance with one embodiment at least one elastic member is provided in a central area between the underside of the top section and the frame bottom.

The invention also extends to a washing machine lid and to a washer machine.

### BRIEF DESCRIPTION OF THE DRAWING

The present invention will now be described in more detail by way of non-limiting examples and with reference to the accompanying drawing, in which:

FIG. 1 is an exploded view of a lid assembly for a washing machine, and

FIG. 2 is a sectional view from the side illustrating fixation between different parts of the lid assembly.

### DETAILED DESCRIPTION

In the following a lid assembly for a washing machine will be described. In the figures, like reference numerals designate identical or corresponding elements throughout the several figures. It will be appreciated that these figures are for illustration only and are not in any way restricting the scope of the invention. Also it is possible to combine features from different described embodiments to meet specific implementation needs.

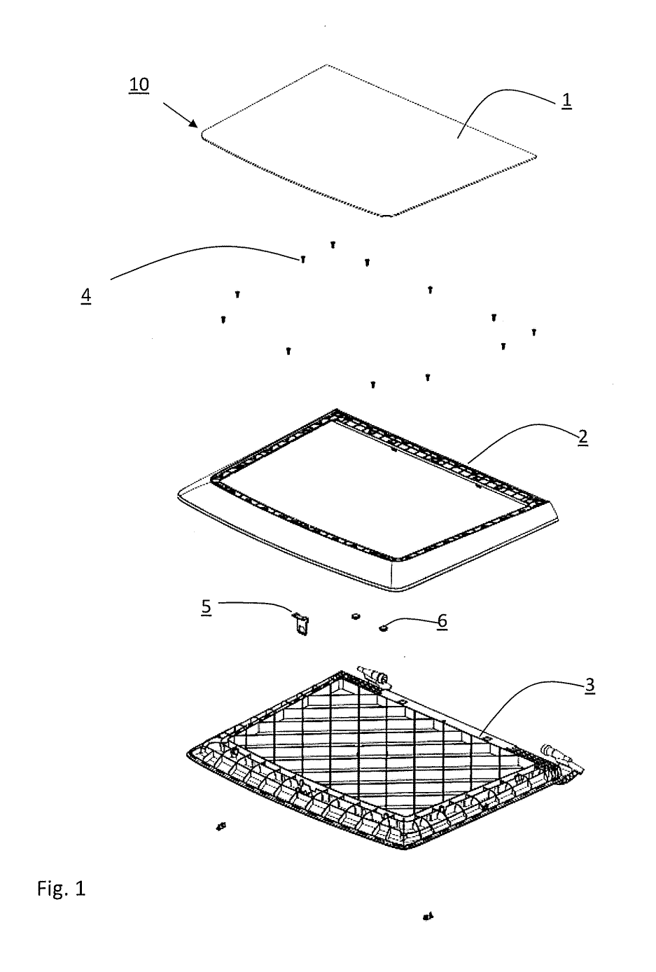

In FIG. 1 an exploded view of a lid assembly 10 for a washing machine is shown. The lid assembly 10 comprises a top section 1, a lid frame top 2 and a lid frame bottom 3. The top section 1 is secured to the lid frame top 2. The frame top 2 has an inner surface adapted to the thickness and size of the top section 1 such that the top section 1 can be received by the top frame 2 and fit in the frame top 2. The lid frame 2 is secured to the lid frame bottom 3. The lid frame top 2 can for example be snap fit onto the lid frame bottom 3. Alternatively or in addition to the snap fit connection, the lid frame top 2 can be screwed onto the lid frame bottom 3 using screws 4. In addition the lid assembly 10 may or may not comprise a door hook 5.

The top section 1 can be secured to the frame, in this embodiment formed by the lid frame top 2 and lid frame bottom 3, by glue or some adhesive. The design with a frame formed by a frame top 3 and frame bottom 3 where a top section is attached to the frame top enables a modular design of the lid assembly. In particular it is made possible to provide a large variety of designs of the lid assembly using very few assembly parts. This is because the top section 1 can be given any design and be made from any material as long as the outer measurements fits in the frame top. IN particular the top section 1 can be made from different materials. In accordance with one embodiment the top section 1 is made of a glass material. In accordance with one embodiment the top section 1 l made from a plastics material. In accordance with one embodiment the top section 1 is made from a metal material.

In order to reduce the risk of breaking the top section 1 when formed by glass or some other fragile material when using the washing machine onto which the lid assembly 10 can be mounted, elastic members 6 or at least one elastic member 6 can be located under the top section 1. In particular the elastic members 6 can be located in a central area well inside the periphery of the top section 1. For example the elastic members 6 can be located in the range of 5-30 cm from the periphery of the top section 1. In particular an elastic member can be located at least 10 cm from the periphery of the top section 1. In accordance with one embodiment a number of elastic members 6 are provided. In particular at least two elastic members 6 are provided. The elastic member(s) 6 can be formed by an elastomer pads or rubber pads. In an alternative embodiment the elastic member(s) are formed by an elastomer sheet or a rubber sheet.

In accordance with one embodiment the elastic member(s) 6 supplement an elastic material located at the periphery under the top section 1. Hence, in such an embodiment the top section will be supported by an elastic material both at its periphery and in a central area when resting on a lid frame.

By providing elastic member(s) 6 under the central area of the top section 1 made by glass a number of advantages can be achieved. For example, the risk of breaking the glass will be reduced since the glass top section 1 is supported not only at the periphery of the glass top section 1 by an elastic material provided under the periphery of the glass top section 1, but also under the central area of the glass top section 1. Because the risk of breaking the glass is reduced, the thickness of the glass top section can be reduced, which in turn reduces the weight of the lid assembly 10 and thereby makes it easier to handle the lid of the washing machine. Also, there is a reduced risk of scratching the glass top section from underneath should the lid be handled carelessly and a heavy impact is forced onto the glass top section.

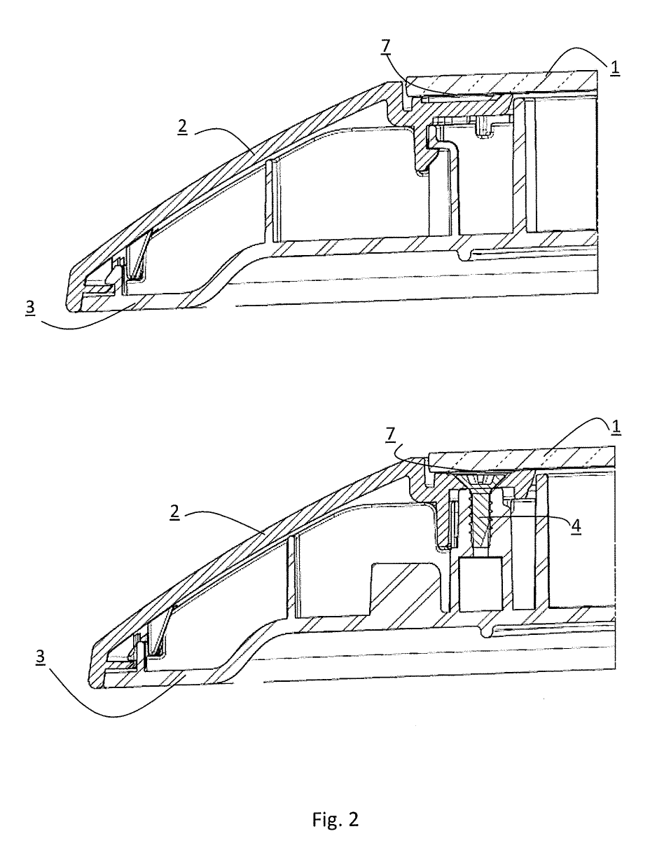

In FIG. 2 a partial sectional view from the side of an assembled lid assembly 10 is shown. Two different embodiments are shown in FIG. 2. An assembly 10 where the top frame 2 is fixed to the bottom frame 3 with screws 5 is shown in the bottom view. An assembly 10 where the top frame 2 is fixed to the bottom frame 3 with snap fit is shown in the top view. The top section 1, which can be made from any suitable material is attached with glue or adhesive at 7.

The washing machine having a lid assembly as described herein makes it possible to produce a lid which can have a varying design and at the same time be produced with few components.

1. A lid assembly for a washing machine, characterized in that the lid assembly comprises a frame formed by a frame bottom and a frame top attached to the frame bottom and top section attached to the frame top.

2. The lid assembly according to claim 1, wherein the frame top has an inner surface adapted to fit with the top section.

3. The lid assembly according to claim 1, wherein the frame top is attached to the frame bottom by screws.

4. The lid assembly according to claim 1, wherein the frame top is snap fit to the frame bottom.

5. The lid assembly according to claim 1, wherein the top section is attached to the frame top by glue or adhesive.

6. The lid assembly according to claim 1, at least one elastic member is provided in a central area between the underside of the top section and the frame bottom.

7. A washing machine lid comprising the lid assembly according to claim 1.

8. A washing machine comprising the washing machine lid according to claim 7.
